(19) United States
(12) Patent Application Publication
(10) Pub. No.: US 2010/0195289 A1
(43) Pub. Date: Aug. 5, 2010

(54) MODULAR FRONT-PANEL CONNECTIVITY ON STANDARD ARCHITECTURE SERVER APPLIANCES

(75) Inventor: Winfried Hubal, Leonberg (DE)

Correspondence Address: WEINGARTEN, SCHURGIN, GAGNEBIN & LEBOVICI LLP, TEN POST OFFICE SQUARE, BOSTON, MA, 02109, US

(73) Assignee: DIALOGIC CORPORATION, Montreal (CA)

(21) Appl. No.: 12/362,871

(22) Filed: Jan. 30, 2009

(51) Int. Cl. G06F 1/16

(52) U.S. Cl. 361/733

(57) ABSTRACT

A system and method for constructing a housing, such as a rack-mountable housing, for computer and telecommunications equipment, and for arranging modules, circuit boards, and other components within such a housing, to enable integration of telecommunications and information technology (IT) application services for delivering next generation, converged, network and multimedia services. The system and method provides a rack-mount server system with one or more line interface modules accessible from the front panel of the system housing, and a motherboard and a backplane with a switch fabric for allowing interconnection of the motherboard with any of the line interface modules. The rack-mount server system provides access to the high level of computing power, advanced storage technology, and standard operating systems of rack-mount server platforms, while retaining the modularity and front-panel connectivity of conventional rack-mountable telecommunications equipment.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF THE INVENTION

The present invention relates generally to computer and telecommunications equipment, and housings for such equipment. More specifically, the present invention relates to a system and method of constructing housings, such as rack-mountable housings, for computer and telecommunications equipment, and arranging modules, circuit boards, and other components within such housings, thereby enabling integration of telecommunications and information technology (IT) application services for delivering next generation, converged, network and multimedia services.

### BACKGROUND OF THE INVENTION

For many years, housings for computer and telecommunications equipment have been configured as rack-mountable housings for making more efficient use of the available space for such equipment, and for facilitating quick installation and removal of modules, circuit boards, and/or other components associated with such equipment. For example, a rack-mountable housing for telecommunications equipment typically includes a frame having a front panel and a rear panel. The housing may contain one or more line interface boards that interface to particular types of media for connection to the public switched telephone network (PSTN), a motherboard with a processor that controls the operation of the line interface boards, and a backplane. The line interface boards are typically configured as “hot-swappable” modules, which can be installed from the front panel to mate with connectors on the backplane toward the rear panel. Interface connectors on the line interface boards can also be accessed from the front panel of the housing.

Like rack-mountable housings for telecommunications equipment, rack-mountable housings for computer equipment typically include frames having front and rear panels. Such computer equipment may comprise a server system including a motherboard and one or more daughter boards, a number of hard disk drives, and a backplane. For example, FIG. 1 depicts a conventional rack-mount server system 100 including a housing 150 with a front cage assembly 104 and a frame 102, which has a front panel 103 and a rear panel 105. It is noted that the housing 150, the front cage assembly 104, and the frame 102 are partially shown in FIG. 1 for clarity of illustration. As shown in FIG. 1, the rack-mount server system 100 includes a motherboard 114 having at least one enhancement slot 118, a riser board 120, a number of hard disk drives 108a, 108b, a backplane 109, a cooling system 112, and redundant power supplies 110a, 110b. In the conventional rack-mount server system 100, the front cage assembly 104 includes a plurality of regions 113a, 113b, each of which can be configured with slide rails (not shown) to allow the hard disk drives 108a, 108b to be easily pulled out of the housing 150 from the front panel 103, and to be slid back into the housing 150 for connection to the backplane 109 toward the rear panel 105. Further, the motherboard 114 may be provided with at least one controller, such as a controller 117, at least one processor, such as a processor 116, and at least one network interface, such as a network interface 111. For example, the controller 117 may be operative to control the hard disk drives 108a, 108b, which are communicably coupled to the controller 117 via cables 121a, 121b, respectively, such as cables that comply with the serial attached SCSI (SAS) standard, interconnecting the backplane 109 and the motherboard 114. Moreover, the processor 116 may be operative to host one or more applications running on standard operating systems, such as WINDOWS Server 2003 sold by Microsoft Corporation, Redmond, Wash., USA, or LINUX or other UNIX variant. In addition, the network interface 111 may be a Gigabit Ethernet (GbE) interface for communicating over a private or public network (not shown), such as the Internet.

In recent years, numerous business models and application services have been developed that involve bridging the infrastructures of multiple networks, such as the Internet protocol (IP) network and the public switched telephone network (PSTN), to deliver next generation, converged, network and multimedia services. While such business models and application services typically require the high level of computing power, advanced storage technology, and standard operating systems that are generally available in rack-mount server systems, such as the conventional rack-mount server system 100 of FIG. 1, they can also benefit from the modularity and front-panel connectivity provided by conventional rack-mountable telecommunications equipment, including the capability of connecting to private branch exchanges (PBXs) or directly implementing the function of a PBX. Such modularity and front-panel connectivity can be provided in conventional rack-mountable telecommunications equipment through the use of open telecommunications platforms for implementing “hot-swappable” line interface boards operative to bridge the IP and PSTN network infrastructures. Such open telecommunications platforms typically comply with the Advanced Telecommunications Computing Architecture (AdvancedTCA) Specification, Revision 2.0, 2006, published by the PCI Industrial Computer Manufactures Group (PICMG). In this context, “hot-swappable” means that each line interface board can be installed and removed from the telecommunications equipment without turning-off the power to the equipment, thereby avoiding disruption to the other line interface boards. Further, interface connectors on the line interface boards are accessible from the front panel of the equipment housing. However, such open telecommunications platforms for implementing hot-swappable line interface boards have not heretofore been easily incorporated into the platforms of conventional rack-mount server systems.

Accordingly, there is a need for computer and telecommunications equipment and housings for such equipment that allow access to the high level of computing power, advanced storage technology, and standard operating systems of rack-mount server systems, while retaining the modularity and front-panel connectivity of conventional rack-mountable telecommunications equipment.

### BRIEF SUMMARY OF THE INVENTION

In accordance with the present invention, a system and method is provided for constructing a housing, such as a rack-mountable housing, for computer and telecommunications equipment, and for arranging modules, circuit boards, and other components within such a housing, to enable integration of telecommunications and information technology (IT) application services for delivering next generation, converged, network and multimedia services. The presently disclosed computer and telecommunications housing and equipment are configured to provide access to the high level of computing power, advanced storage technology, and standard operating systems of rack-mount server systems, while retaining the modularity and front-panel connectivity of conventional rack-mountable telecommunications equipment.

In one aspect, a housing for a rack-mount server system includes a frame having a front panel and a rear panel, and a front cage assembly. The rack-mount server system includes a motherboard, one or more daughter boards, one or more line interface modules, one or more optional data storage devices such as a hard disk drive module or a solid-state drive (SSD) module, and a backplane. The front cage assembly includes a plurality of predefined regions, each of which can be configured to receive either one of the line interface modules or, optionally, the hard disk drive or SSD module. In one aspect, the line interface modules, and the optional hard disk drive or SSD module, are configured as “hot-swappable” modules that can be installed from the front panel through respective regions of the front cage assembly to mate with connectors (the “front connectors”) on the side of the backplane facing the front panel. Interface connectors on the line interface modules are also accessible from the front panel of the housing. The backplane includes a switch fabric, which, when the line interface modules are mated with the front connectors on the backplane, communicably couples the line interface modules to the backplane.

In an exemplary aspect, at least one connector (the “rear connector”) is disposed on the opposite side of the backplane facing the rear panel for communicably coupling the switch fabric to the motherboard via at least one transmission medium such as a high speed serial cable. In one aspect, the line interface modules are implemented as interface boards in Advanced Mezzanine Card (AdvancedMC) form factor, the switch fabric is implemented as a PCIe compliant switch, and the high speed serial cable is contained internal to the housing and configured to use PCIe technology. Moreover, in one aspect, the connection from the rear connector on the backplane to the switch fabric conforms to PCI and PCIe architecture, allowing the motherboard, acting as a master or higher-level switch, to directly communicate with any of the line interface modules.

In another exemplary aspect, the daughter boards include a high speed serial interface board, and the motherboard includes at least one enhancement slot configured to receive the high speed serial interface board. In still another exemplary aspect, the rack-mount server system further includes a riser board connected to the motherboard, and an expansion board coupleable to the riser board. In this aspect, the high speed serial interface board is implemented on the expansion board, thereby obviating the need to open the system housing to insert or remove the serial interface board into/from an enhancement slot. The high speed serial cable is operatively connected to the high speed serial interface board to communicably couple the motherboard to the switch fabric of the backplane. In one aspect, the high speed serial interface board, the enhancement slot of the motherboard, and the riser board, are configured to comply with the PCIe standard.

By providing a rack-mount server system that includes one or more line interface modules accessible from the front panel of the system housing, and a motherboard communicably coupled to a backplane with a switch fabric for allowing the motherboard to directly communicate with any of the line interface modules, access to the high level of computing power, advanced storage technology, and standard operating systems of rack-mount server platforms can be provided, while retaining the modularity and front-panel connectivity of conventional rack-mountable telecommunications equipment. Moreover, because it can be manufactured using standard motherboard hardware and substantially the same housing, power supplies, and cooling system as in conventional rack-mount server systems, which are generally produced in high volume, the presently disclosed rack-mount server system can be provided at reduced cost, typically less than the cost of proprietary rack-mount systems such as those used in the telecommunications industry.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a perspective view of a conventional rack-mount server system;

FIG. 2 is a block diagram illustrating a rack-mount server system according to an exemplary embodiment of the present invention;

FIG. 3 is a flow diagram illustrating a method of the rack-mount server system of FIG. 2; and

FIG. 4 is a perspective view of a rack-mount server system connected to an expansion box according to another exemplary embodiment of the present invention.

### DETAILED DESCRIPTION OF THE INVENTION

A system and method is disclosed for constructing a housing, including but not limited to a rack-mountable housing for computer and telecommunications equipment, and for arranging modules, circuit boards, and other components within such a housing, to enable integration of telecommunications and information technology (IT) application services for delivering next generation, converged, network and multimedia services. In one embodiment, the disclosed system and method provides a rack-mount server system including one or more line interface modules accessible from the front panel of the system housing, and a motherboard communicably coupled to a backplane with a switch fabric for allowing the motherboard to directly communicate with any of the line interface modules. The rack-mount server system provides access to the high level of computing power, advanced storage technology, and standard operating systems of rack-mount server platforms, while retaining the modularity and front-panel connectivity of conventional rack-mountable telecommunications equipment.

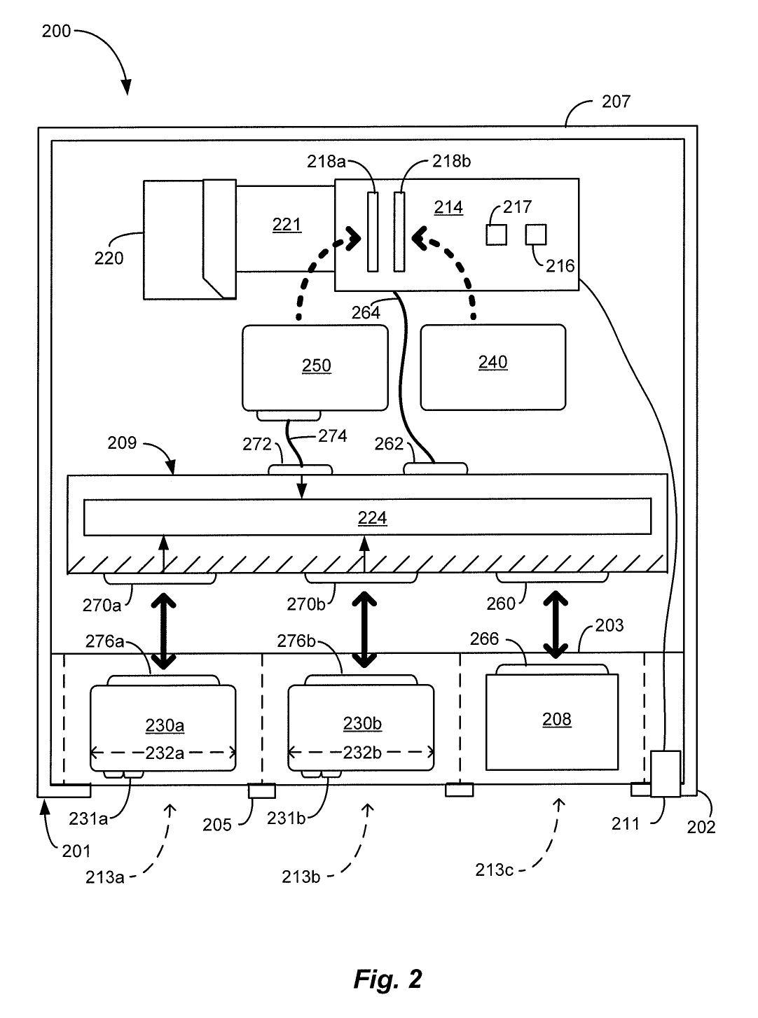

FIG. 2 depicts an illustrative embodiment of a rack-mount server system 200, in accordance with the present invention. As shown in FIG. 2, the rack-mount server system 200 includes a housing 201 with a front cage assembly 203 and a frame 202, which has a front panel 205 and a rear panel 207. It is noted that the housing 201, the front cage assembly 203, and the frame 202 are partially shown in FIG. 2 for clarity of illustration. The rack-mount server system 200 further includes a motherboard 214 having enhancement slots 218a, 218b, a riser board 220, at least one data storage device 208 such as a solid-state drive (SSD) module, and a backplane 209. It is understood that the rack-mount server system 200 can also include a cooling system and redundant power supplies, as in conventional rack-mount server systems. The cooling system and the redundant power supplies of the rack-mount server system 200 are not shown in FIG. 2 for clarity of illustration.

In the rack-mount server system 200, the front cage assembly 203 includes a plurality of regions 213a, 213b, 213c, at least one of which can be configured with slide rails (not shown) to allow the SSD module 208 to be easily pulled out of the housing 201 from the front panel 205, and to be slid back into the housing 201, causing a connector 266 on the SSD module 208 to mate with a connector 260 on the side of the backplane 209 facing the front panel 205. In one embodiment, multiple data storage devices like the SSD module 208 are configured to be “hot-swappable” so that each module 208 can be pulled out of and slid back into the housing 201 without having to turn-off the system power, thereby avoiding disruption to the other data storage devices and any other components of the rack-mount server system 200. The motherboard 214 is provided with at least one controller, such as controller 217, at least one processor, such as processor 216, and at least one network interface, such as network interface 211. The controller 217 is operative to control the SSD module 208, which is communicably coupled to the controller 217 via a connector 262 on the side of the backplane 209 facing the rear panel 207, and a cable 264 interconnecting the connector 262 and the motherboard 214. For example, the cable 264 may comply with the serial attached SCSI (SAS) standard or any other suitable type of cable, and the connector 262 may be an SAS connector or any other suitable type of connector. Further, the processor 216 is operative to host one or more applications running on standard operating systems, such as WINDOWS Server 2003, LINUX or other UNIX variant, or any other suitable operating system. Moreover, the network interface 211 may be a Gigabit Ethernet (GbE) interface, or any other suitable type of network interface, for communicating over a private or public network (not shown), such as the Internet.

As shown in FIG. 2, the rack-mount server system 200 further includes a number of line interface modules 230a, 230b, each operative to provide an interface between the infrastructures of multiple networks, such as the IP and PSTN networks, the IP network and an asynchronous transfer mode (ATM) network, a pair of IP networks as in an Internet gateway firewall or a session border controller, or any other suitable types of networks. For example, each of the line interface modules 230a, 230b may implement the functionality of the Dialogic® Diva® Media Board sold by Dialogic Corporation, Montreal, Quebec, Canada, or any other suitable interface board. As described above with reference to the SSD module 208, the regions 213a, 213b within the front cage assembly 203 can be configured to receive the line interface modules 230a, 230b, respectively, allowing each of these modules to be installed and removed from the front of the system housing 201. Interface connectors 231a, 231b on the line interface modules 230a, 230b, respectively, can also be accessed from the front panel of the housing. During installation of the line interface modules 230a, 230b, connectors 276a, 276b on the line interface modules mate with connectors 270a, 270b, respectively, on the side of the backplane 209 facing the front panel 205. In one embodiment, the line interface modules 230a, 230b are configured to be hot-swappable so that each line interface module can be installed and removed from the front of the system housing 201 without having to turn-off the system power, thereby avoiding disruption to the other line interface modules and any other component of the rack-mount server system 200. It is noted that the backplane 209 has a thickness sufficient to withstand the “plug-in” and “pull-out” forces generated from repeated installation and removal of the SSD module 208 and the line interface modules 230a, 230b from the front of the system housing 201.

As further shown in FIG. 2, the backplane 209 includes at least one switch fabric 224, which, when the connectors 276a, 276b on the line interface modules are mated with the connectors 270a, 270b, respectively, on the backplane 209, communicably couples the line interface modules 230a, 230b to the backplane 209. Moreover, a connector 272 disposed on the side of the backplane 209 facing the rear panel 207 is adapted to communicably couple the switch fabric 224 to the motherboard 214 via a transmission medium 274 and a high speed serial interface board 250. For example, the line interface modules 230a, 230b may be implemented as circuit boards in specified form factors 232a, 232b, respectively, such as the Advanced Mezzanine Card (AdvancedMC) form factor, or any other suitable form factor. Further, the switch fabric 224 may be implemented as a PCIe compliant switch, an Ethernet switch, or any other suitable type of switch, and the transmission medium 274 may be implemented as a high speed serial cable, contained internal to the housing 201, that uses PCIe technology or any other suitable cabling technology. Moreover, in one embodiment, the connection from the connector 272 to the switch fabric 224 conforms to PCI and PCIe architecture, thereby making the line interface modules 230a, 230b appear to the motherboard 214 as PCIe compatible devices capable of communicating with the motherboard 214 and with each other. The AdvancedMC standard is described in the AdvancedMC (AMC.0) Specification, Revision 2.0, 2006, published by the PCI Industrial Computer Manufactures Group (PICMG). Moreover, the PCI standard is described in the PCI Local Bus Specification, Revision 3.0. 2004; the PCIe standard is described in the PCI Express Base Specification, Revision 2.0, 2006; and the PCIe cabling standard is described in the PCI Express External Cabling Specification, Revision 1.0, 2007, each of which is published by the Peripheral Component Interconnect Special Interest Group (PCI-SIG).

The high speed serial interface board 250 is operative to provide a high speed serial interface between the switch fabric 224 of the backplane 209 and the motherboard 214. In the presently disclosed embodiment, the high speed serial interface board 250 is received in the enhancement slot 218a on the motherboard 214, and the high speed serial cable 274 connects the serial interface board 250 to the connector 272 on the backplane 209. In an alternative embodiment, the circuitry of the high speed serial interface board 250 can be implemented on an expansion board 221 coupleable to the riser board 220, which is communicably connected to the motherboard 214. In one embodiment, the switch fabric 224, the high speed serial cable 274, the high speed serial interface board 250, the enhancement slots 218a, 218b, and the riser board 220, are designed using PCI and PCIe technology, providing sufficient bandwidth to transport data, such as multimedia data including but not limited to voice data, from the line interface modules 230a, 230b to the motherboard 214 for subsequent processing.

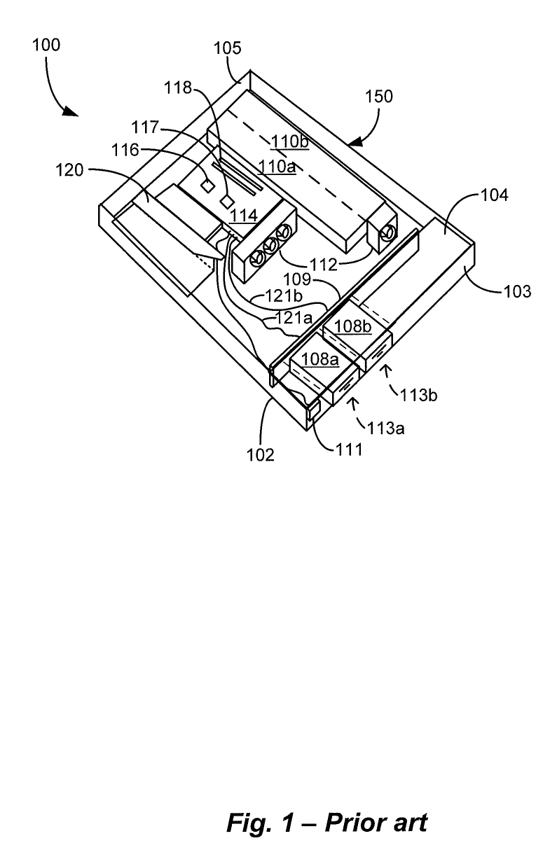

As described above, the regions 213a, 213b within the front cage assembly 203 can be configured to receive the line interface modules 230a, 230b, respectively, thereby allowing each line interface module 230a, 230b to be installed and removed from the front of the system housing 201. In one embodiment, the housing 201 and the front cage assembly 203 of the rack-mount server system 200 are like the housing 150 and front cage assembly 104 of the conventional rack-mount server system 100 (see FIG. 1). Moreover, one or more of the regions within the front cage assembly 203, which are typically configured to receive data storage devices such as hard disk drives, are reconfigured to receive one or more of the line interface modules 230a, 230b. For example, the line interface modules 230a, 230b may be implemented as interface boards in the AdvancedMC form factor and designed to be accommodated in the reconfigured regions of the front cage assembly 203. Because each of the line interface modules 230a, 230b implemented in the AdvancedMC form factor would typically have a power dissipation very close to that of a hard disk drive, e.g., less than about 25 Watts, a cooling system like the cooling system 180 (see FIG. 1) of the conventional rack-mount server system 100 may be employed in the rack-mount server system 200, assuming no substantial deviations are made in the form factor of the backplane 209 from the form factor of the backplane 109 (see FIG. 1) employed in the conventional system 100.

It is noted that when one or more of the regions within the front cage assembly 203 are reconfigured to receive the line interface modules 230a, 230b, there may no longer be enough space available in the front cage assembly 203 to accommodate multiple hard disk drives, which are typically implemented as redundant data storage devices. For this reason, in one embodiment, the rack-mount server system 200 is provided with the single SSD module 208, which may not require a redundant configuration due to no moving mechanical parts. In an alternative embodiment, the SSD module 208 may be omitted from the rack-mount server system 200 and replaced with one or more memory chips, such as Flash memory chips, on the motherboard 214, thereby freeing up space in the front cage assembly 203 for another line interface module or any other suitable module. In still another embodiment, the rack-mount server system 200 may access one or more remote data storage devices, such as network attached storage (NAS) devices, over a network (not shown) via the GbE interface 211.

The presently disclosed rack-mount server system 200 will be better understood with reference to the following illustrative example. In this example, the housing 201 and the front cage assembly 203 of the rack-mount server system 200 (see FIG. 2) are like the housing 150 and the front cage assembly 104, respectively, of the conventional rack-mount server system 100 (see FIG. 1). Each of the above-described regions within the front cage assembly 203 therefore provides sufficient space to receive a hard disk drive, which typically has dimensions of about 100 mm by 15 mm by 145 mm. These dimensions are sufficient to accommodate a line interface module (i.e., the line interface module 230a or 230b) implemented as a circuit board in the AdvancedMC form factor. In this example, the line interface modules 230a, 230b are implemented as Advanced Mezzanine Cards designed for direct interconnection with the backplane 209 via the connectors 270a, 270b, respectively, in compliance with the AdvancedMC and MicroTCA standards. Moreover, the line interface modules 230a, 230b are designed to be hot-swappable, and therefore the power terminals (not shown) and high speed serial data line terminals (not shown) of the connectors 270a, 270b on the backplane 209 are designed to support hot-swapping, in compliance with the PCI/PCIe and AdvancedMC/MicroTCA standards. The MicroTCA standard is described in the Micro Telecommunications Computing Architecture (MicroTCA.0) Specification, Revision 1.0, 2006, which is published by the PICMG.

In this illustrative example, the switch fabric 224 communicably coupling the line interface modules 230a, 230b to the backplane 209 complies with the PCI and PCIe standard, and the internal high speed serial cable 274 communicably coupling the switch fabric 224 to the high speed serial interface of the motherboard 214 uses PCIe technology. Moreover, the motherboard 214 is communicably coupleable to the line interface modules 230a, 230b via the connector 272 and the switch fabric 224, which are interconnected to conform to PCI and PCIe architecture. Because, in this configuration, the line interface modules 230a, 230b appear to the motherboard 214 as PCIe compatible devices, the motherboard 214, acting as a master or higher level switch, can directly communicate with any of the line interface modules 230a, 230b to receive multimedia data, such as voice data, from the respective modules for subsequent processing. It is noted that the line interface modules 230a, 230b can also communicate via the switch fabric 224 to exchange data, such as voice data, with each other.

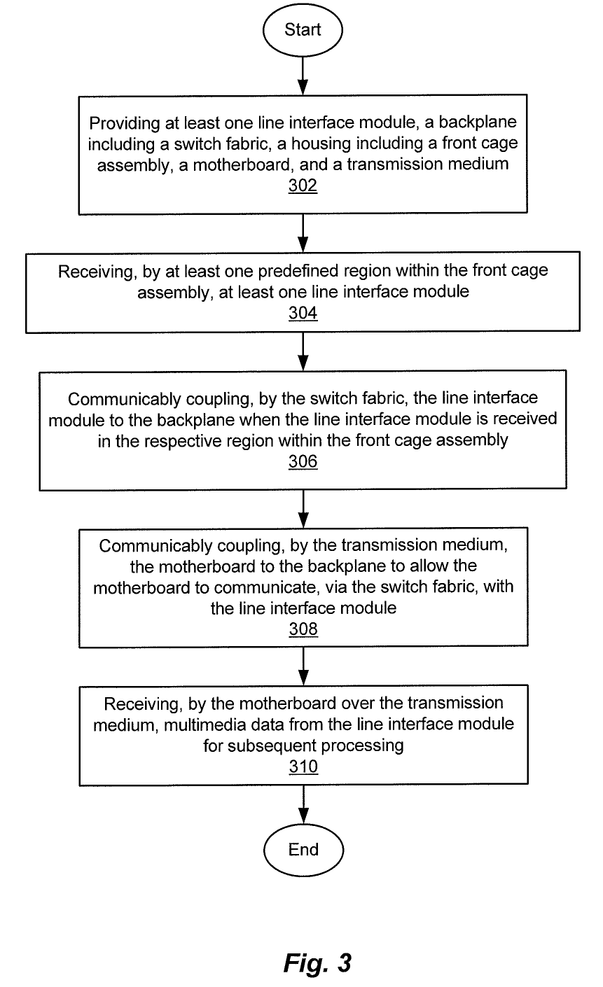

A method of the rack-mount server system 200 is illustrated by reference to FIG. 3. As shown in FIG. 3, the method includes the steps of providing at least one line interface module, a backplane including a switch fabric, a housing including a front cage assembly, a motherboard, and a transmission medium, such as a high speed serial cable (see step 302); receiving, by at least one predefined region within the front cage assembly, at least one line interface module (see step 304); communicably coupling, by the switch fabric, the line interface module to the backplane when the line interface module is received in the respective region within the front cage assembly (see step 306); communicably coupling, by the transmission medium, the motherboard to the backplane to allow the motherboard to communicate, via the switch fabric, with the line interface module (see step 308); and, receiving, by the motherboard over the transmission medium, multimedia data from the respective line interface module for subsequent processing (see step 310).

Having described the above illustrative embodiments, other variations to and modifications of the rack-mount server system 200 may be made. For example, it was described that the respective regions within the front cage assembly 203 can be configured to receive the line interface modules 230a, 230b, and that, during installation of the modules 230a, 230b, the connectors 276a, 276b on the line interface modules can mate with the connectors 270a, 270b, respectively, on the backplane 209. In an alternative embodiment, one or more of these regions within the front cage assembly 203 may be configured to receive either one of the line interface modules 230a, 230b, or a hard disk drive or SSD module, and one or more additional connectors may be provided on the backplane 209 for mating with a corresponding connector on the hard disk drive or SSD module during installation.

In addition, it was described that the line interface modules 230a, 230b can be designed to be hot-swappable in compliance with the PCI or PCIe standard. In an alternative embodiment, the line interface modules 230a, 230b may be designed to be hot-swappable in compliance with the Ethernet standard, the Serial RapidIO standard, or any other suitable standard. The Ethernet standard is described in IEEE Std. 802.3, 2005; and the Serial RapidIO standard is described in the Serial RapidIO Specification, Revision 1.3, 2005.

In addition, it was described that the enhancement slot 218a on the motherboard 214 can be configured to receive the high speed serial interface board 250 for interfacing the motherboard 214 with the switch fabric 224 of the backplane 209. In an alternative embodiment, one or more additional enhancement slots, such as the enhancement slot 218b, may be provided on the motherboard to receive one or more additional daughter boards 240, such as the Dialogic® Multimedia Accelerator Board for PCIe provided in connection with the Dialogic® Multimedia Kit for PCIe sold by Dialogic Corporation for providing accelerated media processing, or any other suitable board.

In addition, it was described that the high speed serial interface board 250 can be received in the enhancement slot 218a on the motherboard 214, or implemented on the expansion board 221 coupled to the riser board 220. In an alternative embodiment, the circuitry of the high speed serial interface board 250 can be implemented either directly on the riser board 220 or directly on the motherboard 214, and the transmission medium 274, such as a high speed serial cable, may be configured to interconnect the high speed serial interface circuitry on the riser board or on the motherboard with the switch fabric 224 of the backplane 209.

In addition, it was described that the transmission medium 274, such as a high speed serial cable, connects the high speed serial interface board 250 to the connector 272 on the backplane 209, thereby communicably connecting, through the serial interface board 250, the motherboard 214 to the switch fabric 224 of the backplane 209. In an alternative embodiment, the high speed serial interface board 250 may include a high speed switch that branches the high speed connection from the serial interface board 250 to the motherboard 214 into two connections, namely, a first high speed connection from the serial interface board 250 to the backplane 209 of the rack-mount server system 200, and a second high speed connection that is externally accessible for connecting, via an additional high speed serial cable, the serial interface board 250 to the backplane of a second rack-mount system.

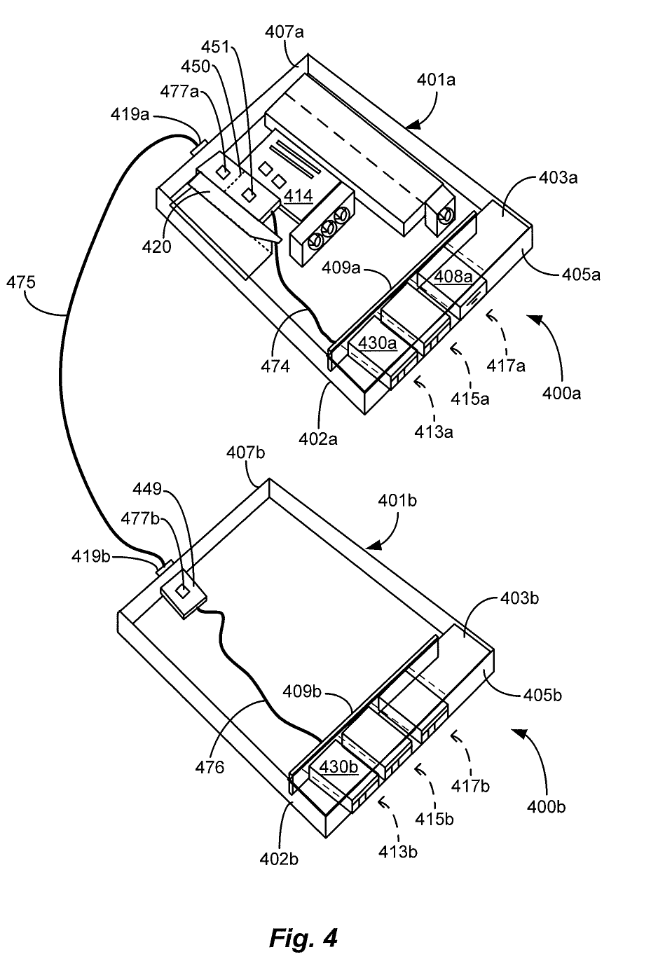

FIG. 4 depicts an illustrative embodiment of a rack-mount server system 400a and a second rack-mount system (the “expansion box”) 400b, which are interconnected by a first transmission medium 475. The rack-mount server system 400a of FIG. 4 is like the rack-mount server system 200 of FIG. 2. For example, the rack-mount server system 400a includes a housing 401a with a front cage assembly 403a, and a frame 402a including a front panel 405a and a rear panel 407a. It is noted that the housing 401a, the front cage assembly 403a, and the frame 402a are partially shown in FIG. 4 for clarity of illustration. The rack-mount server system 400a further includes a motherboard 414, a riser board 420, an electrical and high speed serial interface board 450, an optional data storage device 408a, at least one line interface module 430a, and a backplane 409a. In one embodiment, the functionality of the electrical and high speed serial interface board 450 can be implemented on a corresponding expansion board coupled to the riser board 420, which in turn is communicably connected via a high speed connection to the motherboard 414. The front cage assembly 403a includes a plurality of regions 413a, 415a, 417a, at least one of which can be configured to receive the optional data storage device 408a for connection with the backplane 409a, and at least one of which can be configured to receive the line interface module 430a for connection with the backplane 409a.

As shown in FIG. 4, the rack-mount server system 400a further includes a second transmission medium 474 contained within the housing 401a. The second transmission medium 474 communicably couples the line interface module 430a to the motherboard 414 via the backplane 409a and the high speed serial interface circuitry on the expansion board 450. The electrical interface circuitry on the expansion board 450 operates to interface the first transmission medium 475 to the second transmission medium 474 via a connector 419a on the rear panel 407a. For example, the first transmission medium 475 may be a high speed serial cable that complies with the PCIe cabling standard, and the second transmission medium 474 may be a high speed serial cable that uses PCIe technology or any other suitable cabling technology. The electrical interface circuitry on the expansion board 450 operates as the electrical interface between the first and second transmission mediums 475, 474. For example, the electrical interface circuitry may include an electrical interface device 477a such as the DS50EV401 Quad PCI Express Cable and Backplane Equalizer sold by National Semiconductor Corporation, Santa Clara, Calif., USA, or any other suitable electrical interface. In one embodiment, the DS50EV401 device is employed within the rack-mount server system 400a to provide appropriate equalization, amplification, and electrostatic discharge (ESD) protection to input signals received over the first transmission medium 475.

FIG. 4 also depicts a simplified view of the expansion box 400b for clarity of illustration. As shown in FIG. 4, the expansion box 400b includes a housing 401b with a front cage assembly 403b, and a frame 402b including a front panel 405b and a rear panel 407b. The expansion box 400b further includes at least one line interface module 430b and a backplane 409b. The front cage assembly 403b includes a plurality of regions 413b, 415b, 417b, at least one of which can be configured to receive the line interface module 430b for connection with the backplane 409b. Moreover, the expansion box 400b includes a third transmission medium 476 contained within the housing 401b, and electrical interface circuitry on an electrical interface board 449 that operates to interface the first transmission medium 475 to the third transmission medium 476 via a connector 419b on the rear panel 407b. Like the second transmission medium 474, the third transmission medium 476 may be a high speed serial cable that uses PCIe technology or any other suitable cabling technology. In addition, like the electrical interface circuitry on the expansion board 450, the electrical interface circuitry on the electrical interface board 449 may include an electrical interface device 477b such as the DS50EV401 Quad PCI Express Cable and Backplane Equalizer or any other suitable electrical interface. For example, the DS50EV401 device can be used within the expansion box 400b to provide appropriate equalization, amplification, and electrostatic discharge (ESD) protection to input signals received over the first transmission medium 475. The third transmission medium 476 communicably couples the line interface module 430b to the electrical interface board 449 via the backplane 409b. It is noted that each of the backplanes 409a, 409b includes at least one switch fabric like the switch fabric 224 (see FIG. 2) for communicably coupling the line interface modules 430a, 430b to the backplanes 409a, 409b, respectively.

As further shown in FIG. 4, a high speed switch 451 is disposed on the expansion board 450 within the rack-mount server system 400a. The high speed switch 451 branches the high speed connection from the high speed serial interface circuitry on the expansion board 450 to a second high speed connection, which is externally accessible via the connector 419a on the rear panel 407a. The first transmission medium 475 is coupled between the respective connectors 419a, 419b on the rear panels 407a, 407b, thereby communicably connecting the backplane 409b of the expansion box 400b to the electrical and high speed serial interface circuitry within the rack-mount server system 400a. In this configuration, the line interface modules 430a, 430b included in the rack-mount server system 400a and the expansion box 400b, respectively, appear to the motherboard 414 as PCIe compatible devices capable of communicating with the motherboard 414 and with each other. It is noted that the rack-mount server system 400a and the expansion box 400b may optionally include any suitable PCIe board(s) (not shown) that can be communicably coupled to the backplanes 409a, 409b via the motherboard 414 or any suitable switch fabric(s), respectively. In this way, the rack-mount server system 400a and the expansion box 400b, each equipped with one or more modular, front-panel-connectable line interface modules 430a, 430b and optionally one or more PCIe boards, can be interconnected to allow multimedia data processing with increased flexibility.

It is noted that, like the rack mount server system 400a, the expansion box 400b can be manufactured using substantially the same housing frame, substantially the same cooling system, and substantially the same power supply components as in conventional rack mount server systems, which are generally produced in high volume. The expansion box 400b can therefore be provided at reduced cost, typically less that the cost of proprietary, low volume expansion boxes.

In addition, it was described that the housing 201 of the server system 200 is a rack-mountable housing. In an alternative embodiment, the housing 201 may be a non-rack-mountable housing or any other suitable type of housing.

It will be further appreciated by those of ordinary skill in the art that modifications to and variations of the above-described modular front-panel connectivity on standard architecture server appliances may be made without departing from the inventive concepts disclosed herein. Accordingly, the invention should not be viewed as limited except as by the scope and spirit of the appended claims.

What is claimed is:

1. A server system, comprising:
one or more line interface modules;
a housing including a front cage assembly, the front cage assembly having one or more predefined regions operative to receive one or more of the line interface modules, respectively;
a backplane including a switch fabric, the switch fabric being operative to communicably couple the one or more line interface modules to the backplane when the one or more line interface modules are received in the one or more predefined regions, respectively, within the front cage assembly;
a motherboard; and
a transmission medium operative to communicably couple the motherboard to the backplane, thereby allowing the motherboard to communicate, via the switch fabric, with one or more of the line interface modules for receiving multimedia data from the respective line interface modules for subsequent processing.

2. The system of claim 1 further including a connector disposed on the backplane for each of the one or more line interface modules, the connector being operative to connect the respective line interface module to the switch fabric, and to support hot-swapping of the respective line interface module.

3. The system of claim 1 wherein at least one predefined region within the front cage assembly is further operative to receive a data storage module instead of one of the line interface modules, the data storage module being communicably coupleable to the backplane when the data storage module is received in the respective region within the front cage assembly.

4. The system of claim 3 wherein the system further includes a first connector disposed on the backplane for the one of the line interface modules, and a second connector disposed on the backplane for the data storage module, the first connector being operative to connect the respective line interface module to the switch fabric, and the second connector being operative to connect the data storage module to the backplane.

5. The system of claim 4 wherein the first connector and the second connector are operative to support hot-swapping of the one of the line interface modules and the data storage module, respectively.

6. The system of claim 1 wherein the transmission medium comprises a high speed serial cable.

7. The system of claim 6 further including high speed serial interface circuitry operatively connected between the motherboard and the high speed serial cable.

8. The system of claim 7 wherein:
the high speed serial interface circuitry is implemented on a high speed serial interface board; and
the motherboard includes a first enhancement slot operative to receive the high speed serial interface board.

9. The system of claim 7 wherein:
the system further includes a riser board connected to the motherboard, and an expansion board coupled to the riser board; and
the high speed serial interface circuitry is implemented on the expansion board.

10. The system of claim 7 wherein:
the system further includes a riser board connected to the motherboard; and
the high speed serial interface circuitry is implemented on the riser board.

11. The system of claim 7 wherein the high speed serial interface circuitry is implemented on the motherboard.

12. The system of claim 8 wherein:
the system further includes an accelerator board operative to perform accelerated processing of the multimedia data; and
the motherboard further includes a second enhancement slot operative to receive the accelerator board.

13. The system of claim 1 wherein the one or more line interface modules have an Advanced Mezzanine Card (AdvancedMC) form factor.

14. The system of claim 1 wherein the switch fabric is implemented as one of a PCI and PCIe compliant switch and an Ethernet switch.

15. The system of claim 1 wherein the transmission medium is implemented as a cable, contained internal to the housing, that uses PCIe technology.

16. The system of claim 1 wherein:
the backplane further includes an interface connection operative to interconnect the transmission medium and the switch fabric; and
the interface connection conforms to PCI and PCIe architecture.

17. A method of a server system, comprising the steps of:
providing one or more line interface modules, a backplane including a switch fabric, a housing including a front cage assembly having one or more predefined regions, a motherboard, and a transmission medium;
receiving, by one or more of the predefined regions within the front cage assembly, one or more of the line interface modules, respectively;
communicably coupling, by the switch fabric, the one or more line interface modules to the backplane when the one or more line interface modules are received in the one or more predefined regions, respectively, within the front cage assembly;
communicably coupling, by the transmission medium, the motherboard to the backplane to allow the motherboard to communicate, via the switch fabric, with one or more of the line interface modules; and
receiving, by the motherboard over the transmission medium, multimedia data from the respective line interface modules for subsequent processing.

18. The method of claim 17 further including the steps of:
providing a connector on the backplane for each of the one or more line interface modules; and
operatively connecting, by the connector, the respective line interface module to the switch fabric to support hot-swapping of the respective line interface module.

19. The method of claim 17 further including the steps of:
providing a data storage module, and a connector on the backplane for the data storage module;
receiving, by one of the predefined regions within the front cage assembly, the data storage module instead of one of the line interface modules; and
operatively connecting, by the connector, the data storage module to the backplane when the data storage module is received in the one of the predefined regions within the front cage assembly.

20. The method of claim 19 further including the step of operatively connecting, by the connector, the data storage module to the backplane to support hot-swapping of the data storage module.

21. The method of claim 17 wherein:
the transmission medium comprises a high speed serial cable;
the method further includes the step of providing high speed serial interface circuitry; and
the communicably coupling of the motherboard to the backplane includes communicably coupling, by the high speed serial cable through the high speed serial interface circuitry, the motherboard to the backplane to allow the motherboard to communicate, via the switch fabric, with one or more of the line interface modules.

22. The method of claim 17 wherein the providing of the one or more line interface modules includes providing the one or more line interface modules in an Advanced Mezzanine Card (AdvancedMC) form factor.

23. The method of claim 17 further including the step of implementing the switch fabric as one of a PCI and PCIe compliant switch and an Ethernet switch.

24. The method of claim 17 further including the step of implementing the transmission medium as a cable, contained internal to the housing, that uses PCIe technology.

25. The method of claim 17 wherein:
the providing of the backplane includes providing the backplane including an interface connection; and
the method further includes the step of interconnecting, by the interface connection, the transmission medium and the switch fabric, the interface connection conforming to PCIe architecture.

26. A server system, comprising:
a plurality of line interface modules;
at least one housing including at least one front cage assembly, the front cage assembly having a plurality of predefined regions operative to receive the plurality of line interface modules, respectively;
a plurality of backplanes, each backplane including a switch fabric, the switch fabric being operative to communicably couple at least one of the plurality of line interface modules to the respective backplane when the at least one line interface module is received in the respective predefined region within the front cage assembly;
a motherboard; and
a plurality of transmission mediums operative to communicably couple the motherboard to the plurality of backplanes, respectively, thereby allowing the motherboard to communicate, via the respective switch fabrics, with one or more of the plurality of line interface modules for receiving multimedia data from the respective line interface modules for subsequent processing.

27. The system of claim 26 wherein each line interface module has an Advanced Mezzanine Card (AdvancedMC) form factor.

28. The system of claim 26 wherein each switch fabric is implemented as one of a PCI and PCIe compliant switch and an Ethernet switch.

29. The system of claim 26 wherein each transmission medium is implemented as a cable, contained internal to the at least one housing, that uses PCIe technology.

30. The system of claim 26 wherein:
each backplane further includes an interface connection operative to interconnect one of the plurality of transmission mediums and the switch fabric included in the respective backplane; and
the interface connection conforms to PCIe architecture.
